(19) United States
(12) Patent Application Publication
(10) Pub. No.: US 2020/0403957 A1
(43) Pub. Date: Dec. 24, 2020

(54) SYSTEM FOR IDENTIFYING AND CATEGORIZING IMPORTANT LIFE EVENTS THEN SCHEDULING AND COMPOSING A SHORT FORM WRITTEN MESSAGE

(71) Applicant: FORGET ME NOT AI, INC, Lewes, DE (US)

(72) Inventor: Claudia HOLWILL RAUCH, Washington, DC (US)

(21) Appl. No.: 16/909,194

(22) Filed: Jun. 23, 2020

Related U.S. Application Data
(60) Provisional application No. 62/865,576, filed on Jun. 24, 2019.

(51) Int. Cl. H04L 12/58; G06F 40/279; G06F 9/54; G06N 20/00

(52) U.S. Cl. CPC H04L 51/32; H04L 51/24; H04L 51/12; G06F 9/542; G06F 9/547; G06N 20/00; G06F 40/279

(57) ABSTRACT

The system identifies life events of contacts on social media based on key words, comments, sentiment terms, structured data, and volume of reactions and interactions. The system notifies users of their contact's life events, identifies the opportunities to reach-out across a variety of written channels, and generates a draft of a message to send to the contact appropriate to the life event and communication channel while using machine learning of user feedback to improve both capabilities over time. The system automates the sending of messages at the appropriate time and channel.

### RELATED APPLICATION

This application is related to, and claims priority from, U.S. Provisional Patent Application No. 62/865,576, entitled “Improved System for Gathering Meaningful Insights from Large, Publically-Available, Third-party Data Streams for Identifying and Categorizing Important Life Events then Scheduling and Composing a Short Form Written Message Appropriate as a Response to Life Event Across a Plurality of Online and Offline Communication Channels”, filed on Jun. 24, 2019, the disclosure of which is incorporated here by reference.

### FIELD OF DISCLOSURE

The present disclosure relates to Artificial Intelligence (AI), and more specifically, an ensemble method of artificial intelligence algorithms including Symbolic AI, Slot-filling, and Reinforcement Learning systems to accomplish a specific task of gathering meaningful insights from large, publically-available data sets for the purpose of identifying and categorizing important events and dates; drafting natural language notes in response to those events if the form of traditional human written emails, cards, and handwritten notes; and adapting those responses to better match user style and vocabulary over time.

### BACKGROUND

Machine learning systems are capable of distilling large data sets into meaningful subsets. Machine learning systems, however, have difficulty gathering meaningful insights from unstructured data sets. For example, attempting to extract meaningful data from third-party social media sites is notoriously difficult. Social media sites are primarily structured for human interaction without any machine data transfer capability. Thus, they are difficult to use for gathering and distilling big data.

Machine learning systems specifically vector based Word-Embedding and Recurrent Neural Networks (RNN) systems are able to predict the next word in a human written sentence, often with a high degree of accuracy. However these systems have a very hard time generating an entire note even something simple like a “Thank you” card.

What is needed is an Artificial Intelligence (AI) system that can distill meaningful life events and dates from social media sites and catalogue important dates for important people, then draft complete notes and acknowledgments, so that users can create meaningful contacts (Touchpoints) with important people. Finally scheduling and sending the completed messages in a timely and automated fashion.

By breaking the problem into targeted and specific tasks, a successful application of an ensemble of Narrow Artificial Intelligence with a focus on this specific user problem enables embodiments to achieve a successful system.

### SUMMARY

In one embodiment, a system and method automate the process of collecting life events from third-party social media websites. Once this information has been identified, it can be used to create meaningful communication. For example, it can be used to compose a message to be sent to the individual experiencing the life event referring to the life event in a way similar to other messages. If the user edits the message the edits can be saved and used for future machine learning of communication style.

In another embodiment, a machine learning system is provided for analyzing a plurality of social media posts and comments to identify a plurality of items; categorizing the type of life event; and generating a notification for the user. Likewise, the machine learning system can aggregate a plurality of posts and comments and summarize each life event, and compile a report for the plurality of life events.

In another embodiment, a machine learning system is provided for identifying life events from social media posts and engagements of the post including comments, reactions, emoji symbols, etc. The machine learning system presents this information in an aggregate form, e.g., a dashboard, etc., where the user can take actions including sending an email, text message, card, gift, etc.

In another embodiment, the present disclosure provides a system and method to collect meaningful events from the user, private Customer Relationship Management (CRM), and/or marketing database systems. Once this information has been identified, it can be used to create meaningful communication. For example, it can be used to compose and schedule a message to be sent to the individual experiencing the life event.

In another embodiment, the present disclosure provides a system and method to collect meaningful events from the user, private email, and/or messaging systems. Once this information has been identified, it can be used to create meaningful communication. For example, it can be used to compose and schedule the delivery of flowers with a meaningful message to be sent to the individual experiencing the life event.

### BRIEF DESCRIPTIONS OF DRAWINGS

The accompanying drawings, which are included to provide a further understanding of the invention, illustrate embodiments and together with the detailed description serve to explain the principles of these embodiments. No attempt is made to show structural details of the embodiments in more detail than may be necessary for a fundamental understanding of the embodiments and various ways in which it may be practiced.

FIG. 1 illustrates an embodiment of the life-event identify and response system.

FIG. 2 illustrates a flowchart of an embodiment of steps to facilitate the identification of important events, classification of events, and generating the response for personal and business touchpoints.

FIG. 3 illustrates an embodiment of steps to identify significant events from a stream of social media interactions.

FIG. 4 illustrates an embodiment of steps for identifying which type of life event could be part of the significant post.

FIG. 5 illustrates an embodiment of high-level steps for drafting messages that would be appropriate responses for an action event.

FIG. 6 illustrates an embodiment of the output of selected message and additional selections such as gift and message format to partners via an API.

FIG. 7 illustrates an embodiment of the user interface for receiving an alert about a potential new event on the dashboard of the system.

FIG. 8 illustrates an embodiment of the user interface for reviewing the AI-composed message for the user to send the contact, and the AI-suggested cards and gifts.

FIG. 9 illustrates an embodiment of the email message a user would receive to notify them about a potential life event and the AI-suggested message, cards, and gifts.

FIG. 10 illustrates an embodiment of the email message a user would receive in advance of a scheduled life event and suggested actions.

### DETAILED DESCRIPTION

The following description provides preferred exemplary embodiment(s) only, and is not intended to limit the scope, applicability or configuration of the disclosure. Rather, the following description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

Broadly, the life-event system according to embodiments uses AI to identify and present potential responses to a user so that the user can timely communicate with the contact in relation to a given life-event. For the purposes of this specification, a “user” is one who uses the system, a “contact” is someone the user would like to communicate with after a life-event, and a “life-event” is an event relating to a contact that is significant enough that the user would like to communicate with the contact in relation to the event.

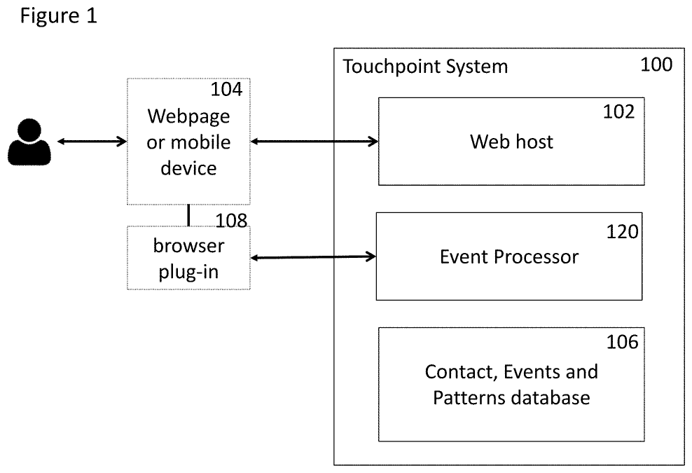

FIG. 1 illustrates an embodiment of the life-event touchpoint automation system 100. The touchpoint system 100 includes a web hosting server 102 for hosting a web page and/or GUI through which a user device 104 or many user devices 104 (not shown) may interact. The user device 104 interacts with the web hosting server 102 via the internet or via some other type of network, e.g., local area network (LAN), wide area network (WAN), cellular network, personal area network (PAN), etc. The web hosting server 102 provides a software as a service (SaaS) delivery model in which the user device 104 accesses software via a web browser in a zero footprint configuration for the user device 104, but other embodiments could use enterprise software, handheld app or computer application software. The web hosting server 102 allows the user device 104 to download and/or install software that permits the user device 104 to use the system 100.

The life-event system 100 includes a life-event database 106 and an event processing server 120 coupled with the web hosting server 102 for storing life event data 130. Life-event data 130 includes data structures comprised of Contacts, Suggestions, Touchpoints and Tasks. Touchpoints corresponding to life events derived from social media posts and conversations, emails, known or user supplied life-event dates, and general holidays and other potential events. For the purpose of this specification, a “social media post” means content posted to a social media website by a contact, and a “response” means content added to the social media website in response to the social media post.

An alternative embodiment uses a system and method for interfacing with a user internet browser (browser plug-in) 108 to provide additional automation and AI intelligence to the user while navigating public social media internet sites.

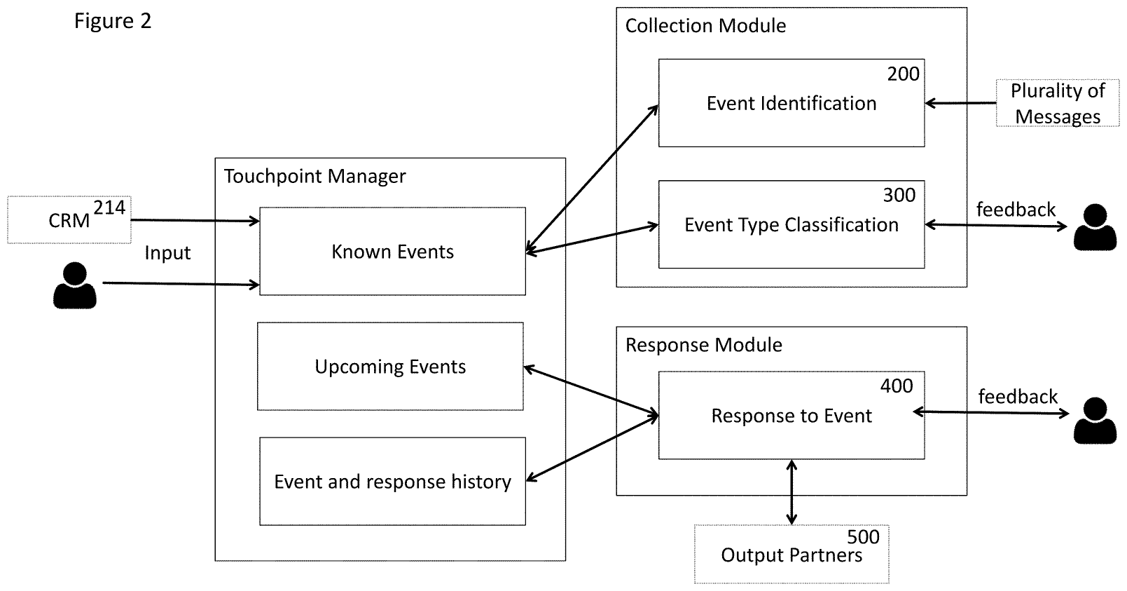

FIG. 2 illustrates a flowchart embodiment of steps to facilitate the identification of important events and finalizing a response for delivery to a contact. As shown the preferred embodiment of the life-event system comprises three steps: an identifying step 200, a categorizing step 300, and an action step 400.

### Identifying Step

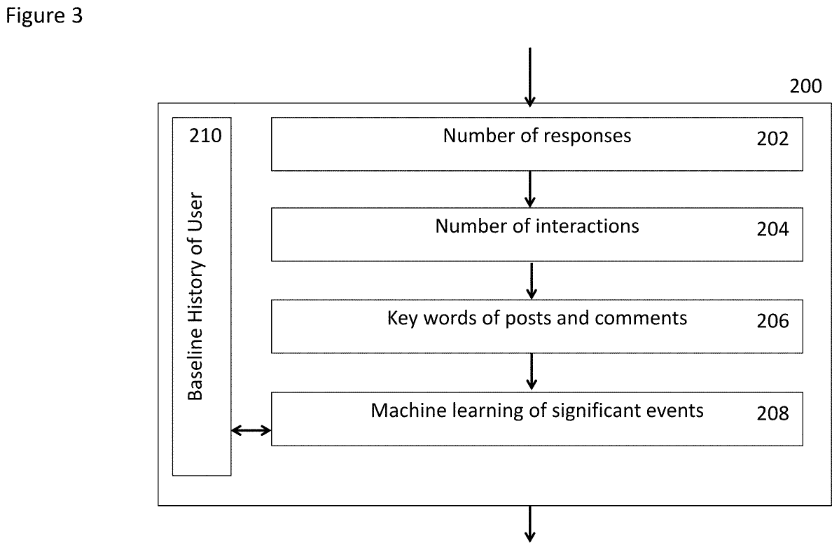

FIG. 3 illustrates an embodiment of the identifying step 200. Broadly, the identifying step 200 uses a baseline 210 to compare new life-event data 130. The baseline 210 comprises historical data from a given contact 150. In one embodiment, the baseline 210 is a collection of historic posts and interactions from a given contact 150. In general, when the event processor 120 receives new life-event data 130, the event processor 120 evaluates the new life-event data 130 by comparing it to the baseline 210 for the same contact. For example, the event processor could use information from things like interactions 204 (e.g., “thumbs-up” emojis or likes) or key words 206 from a post or comments, or frequency of past engagement on social media. For the purposes of this specification, “interactions” mean a response to a social media post, which could be in the form of words, images, video or any combination thereof. For the purposes of this specification, “key words” mean a predefined list of words kept on a key word database.

The identifying step 200 includes a machine learning step 208. In the machine learning step 208, the event processor 120 applies event identifying rules 210 (not shown in FIG. 3) to the new life-event data 130 (e.g., responses 202, interactions 204, and key words 206) and compares it to the baseline 210. The event identifying rules 210 are stored on an event rules database 212. If the event processor 120 determines that a life-event data 130 is significant according to the event identifying rules 201, then the life event data is saved as a significant event 230.

An alternative embodiment uses a system and method for interfacing with a CRM 214 to provide additional life-event data to be saved as a significant event 230.

### Categorizing Step

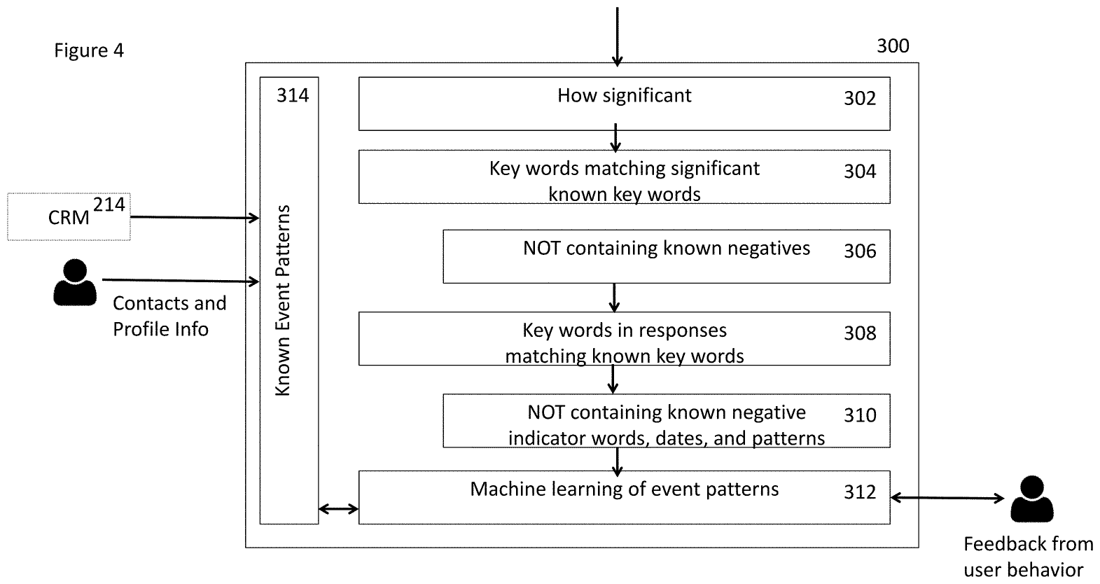

FIG. 4 illustrates an embodiment of the categorizing step 300. Broadly, the categorizing step takes the results from the identifying step 200 and categorizes them. More specifically, the categorizing step 300 determines the what of type of life event should be associated with the significant event 230.

The categorizing step 300 includes a machine learning step 312. In the machine learning step 312, the event processor 120 applies event categorizing rules 320 (not shown in FIG. 4) to a significant event 230. The purpose of categorizing step 300 ultimately to provide a user interface for accepting an item as being a life event that the user wants to respond to, and learning from the decision if future events should be classified as a life event. If the user selects a life event as one to the user wants to take further action, that life event is saved as an action event 330.

The categorizing rules 320 are stored on a categorizing database 322. For example, one categorizing rule 320 could be to evaluate a post for key words 304 matching or being related to known key words for known significant events stored in the known event pattern database 314. Another categorizing rule could be to evaluate for negating terms 306. For the purposes of this specification, “negating terms” are words and concepts that are known to negate life events, for example “just kidding,” “ha ha ha ha, “gotcha,” “April Fools,’ etc. Yet another categorizing rule 320 could be to evaluate for corroborating terms 308. For the purposes of this specification “corroborating terms” are words and concepts like “congratulations,” and “that's wonderful,” etc. Alternatively, a categorizing rule could be a negative word 310. For the purposes of this specification, a “negative word” is a word or words like “you got me,” etc. and negative indicators such as dates or patterns, such as April 1 or “Throwback Thursday”.

The known event pattern database 314 stores event patterns for future evaluations and machine learning. The event processor 120 can import known events from other external systems including contact information from address books, imports from Customer Relationship Management Systems, importing information from social media profile details, and a user interface for users to input known information about their contacts.

### Action Step

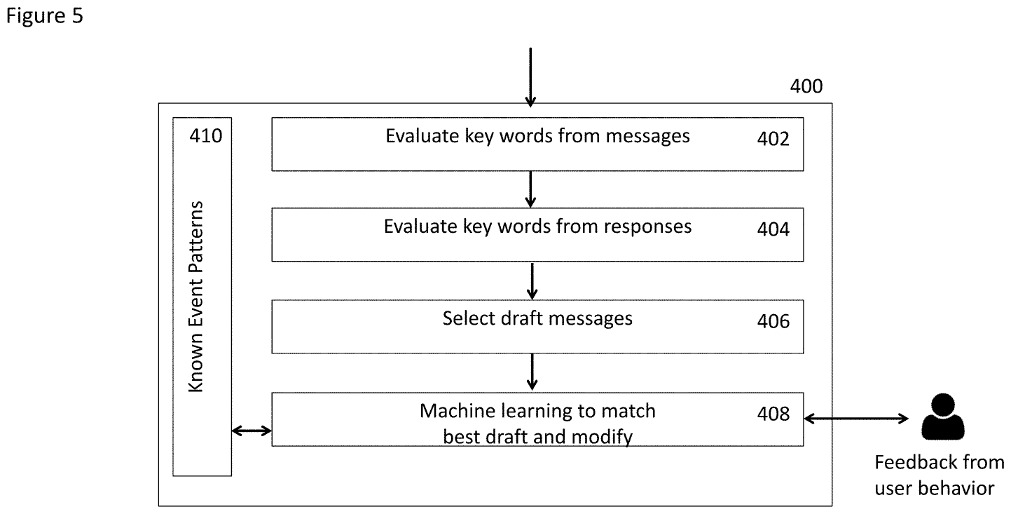

FIG. 5 illustrates an embodiment of the action step 400. The action step 400 is the high-level process for drafting messages for an action event 330. The action step 400 includes a machine learning step 408. In the machine learning step 408, the event processor 120 applies action event rules 420 (not shown in FIG. 5) to an action event.

The action event rules 420 are stored on an action database 422. One example of an action rule 420 could be to collect key words from the messages identified in step 402 and responses 404 (as identified in step 330). A collection of draft messages 406 is stored on a draft messages database 422. The event processor 120 selects a draft message from the draft messages database 422 based the type of event and relationship or additionally on a comparison of key words from messages 402 and responses 404. The event processor presents initial draft messages to the user for feedback and edits to learn potential modifications for future draft messages. Known event patterns are stored in the known event pattern database 410. Once the user edits or confirms the wording of the draft message, that message is saved as the touchpoint message 430.

An alternative embodiment uses a machine learning method to generate the message to best match the life-event and writing style of the User.

Step 1 is reducing the draft message or message template 406 to its component parts to be described as Tokens. For the primary message type of short form notes the component Tokens are as follows: Greeting, Recipient Name, Body, Salutation, and Sender Name.
Step 2, for the Greeting; Recipient Name, Salutation, and Sender Name a system incorporating a Machine Learning process using a Slot-Filling method to modify the selected Tokens based on past User edited content 430 of a significant usage of the same Tokens in previous messages under the same or similar combination of meta-data such as recipient, event-type, and relationship.
Step 3, for the Body a system incorporating a Machine Learning process using an ensemble method of Machine Learning processes potentially including: Recurrent Neural Networks (RNN) with Long Short-Term Memory (LSTM), Markov Model for word prediction with n-grams, or Recurrent Neural Networks (RNN) with Word Embedding Vectors, or simple probabilistic models. The system predicts based on past word changes the most likely word patterns the user would suggest and uses those to build a draft. The event processor presents the refined draft messages to the user for feedback and edits to learn potential modifications for future draft messages. Known event patterns are stored in the known event pattern database 410. Once the user edits or confirms the wording of the draft message, that message is saved as the touchpoint message 430.

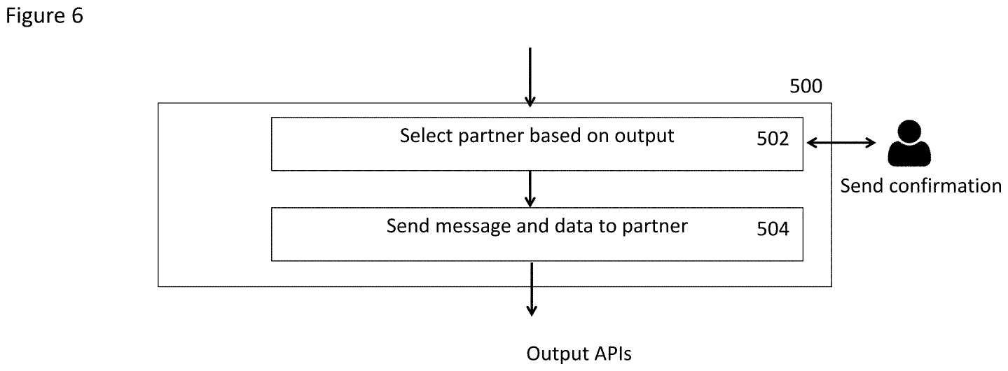

An alternative embodiment is shown in FIG. 6. As shown, the user will be given a suggestion for a partner or can select a partner 502 for the selected message 430. Ordinarily, the partner 502 is a vendor for supplying a gift 540, like flowers or a card. Preferably via an API or an automated email, the selected message 430 is sent to the partner as a gift message 530 to be delivered with the gift 540.

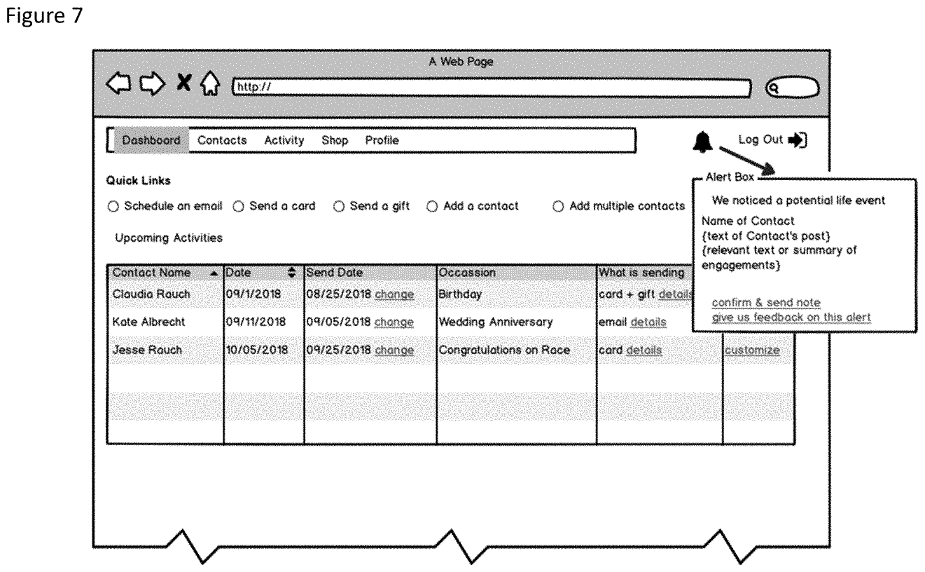

FIG. 7 illustrates an embodiment of the user interface for receiving an alert about a potential new event on the dashboard of the system.

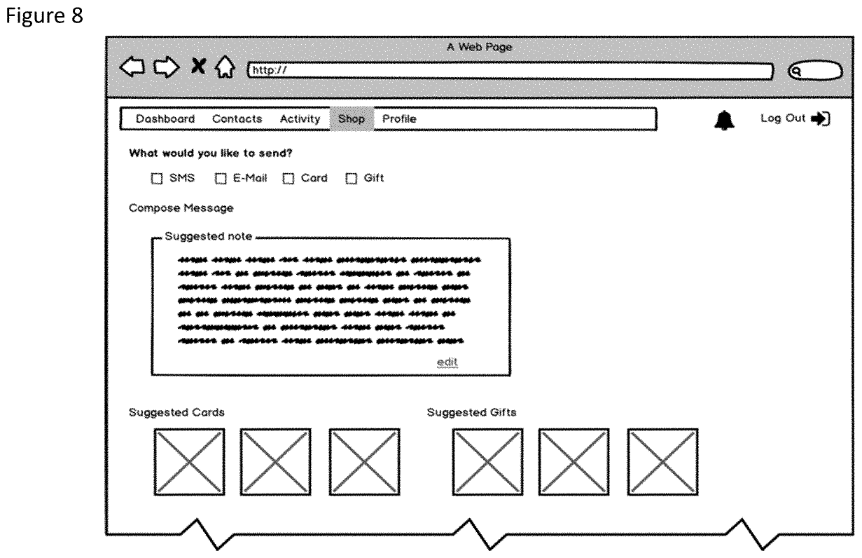

FIG. 8 illustrates an embodiment of the user interface for reviewing the AI-composed message for the user to send the contact, and the AI-suggested cards and gifts.

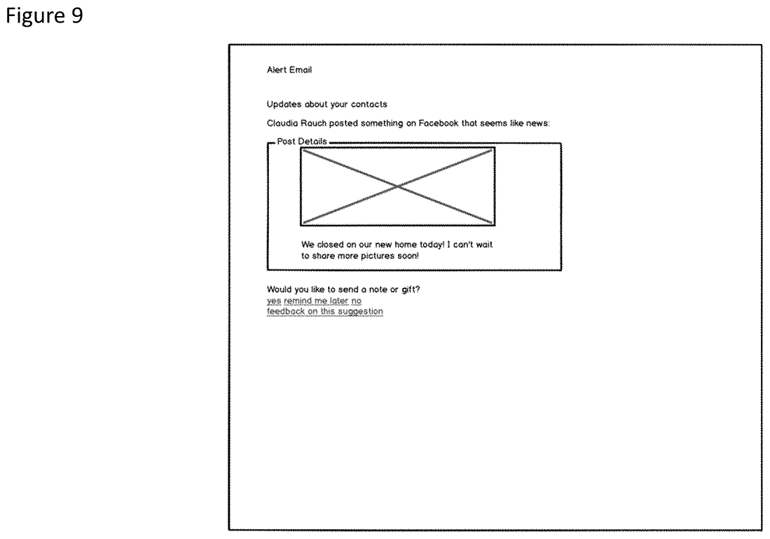

FIG. 9 illustrates an embodiment of the email message a user would receive to notify them about a potential life event and the AI-suggested message, cards, and gifts.

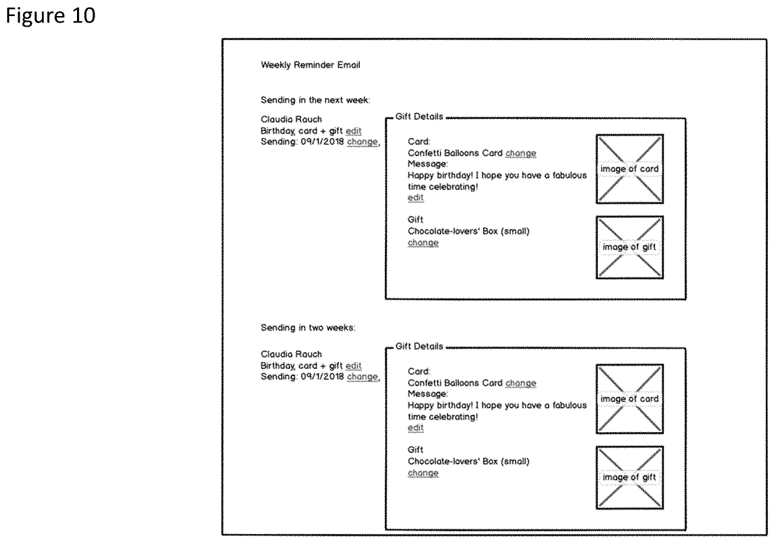

FIG. 10 illustrates an embodiment of the email message a user would receive in advance of a scheduled life event and suggested actions.

What is claimed is:

1-3. (canceled)

4. The computer implemented method of claim 21, further comprising:
identifying the selected social media posts on social media networks based on criteria including: user profile information; frequency of engagement between user and contact via social network platform and electronic communication.

5. The computer implemented method of claim 21, further comprising
send a notification to a user about the life event or status change event that occurred for one of the user's contacts via platform alerts and via email notification; and
presenting the user with a prompt to confirm the notification and for the user to send a message via the platform through one of several options including electronic mail, printed format, or other electronic communication.

6. The computer implemented method of claim 21, wherein user interactions and sent messages are used to improve the filtering criteria.

7. The computer implemented method of claim 21, wherein the type of life event or status change communicated in a social media post is identified by:
analyzing the text of the social media post and associated comments, reactions, interactions, and emoji-style indicators for sentiment and key words;
identifying potential a false positive post based on criteria including dates and key words; and
using a Machine Learning algorithm to classify events as a likely life event.

8. The computer implemented method of claim 7, further comprising collecting life event details from social media profiles, including one or more of birthdates, relationships, employers, and school affiliations.

9. The computer implemented method of claim 7, further comprising identifying key life event information from a local contact database, email system, Marketing Database, or CRM System, including one or more dates.

10. The computer implemented method of claim 4, further comprising collecting life event data from a user interface, and prompting the user for known information about the user's one or more contacts.

11. The computer implemented method of claim 7, further comprising matching previously known life event information to social media signals.

12. The computer implemented method of claim 7, further comprising updating a database of known information for future use.

13. (canceled)

14. A life-event system of claim 19, wherein the server selects a best message template from a plurality of message templates using associated meta-data such as the identified life-event and a relationship between the user and the contact to generate the draft message.

15. The life-event system of claim 19, wherein the event processing server drafts the message with a system incorporating a Machine Learning process using an ensemble method of Machine Learning processes including one or more of:
a) Recurrent Neural Networks (RNN) with Long Short-Term Memory (LSTM),
b) Markov Model for word prediction with n-grams, or
c) Recurrent Neural Networks (RNN) with Word Embedding Vectors, or
d) Probabilistic Models
to predict word edits or word patterns the user would likely have used themselves based on past messages or edits.

16. The life-event system claim 15, wherein the Machine Learning algorithm provides suggestions of a gift to send to the contact by
filtering suggestions based on criteria including one or more of event occasion;
frequency of interactions with the contact; and user-provided criteria.

17. The life-event system of claim 19, wherein the user's interactions and sent messages are used to improve search and filtering criteria for identifying the life-event data.

18. The life-event system of claim 19, wherein the user actions and sent messages are saved for future machine learning.

19. A life-event system, the system comprising:
an event processing server comprising a processor and memory with instructions configured to identify and categorize life-event data, and present an action step to a user,
the event processing server identifying the life event data by:
downloading life-event data from a social media account associated with a contact of the user,
comparing the life-event data to a baseline for the contact, and
saving the life-event data as a significant event based on the comparing step,
the event processing server categorizing the significant event by:
applying a categorizing rule to the significant event,
presenting the significant event to the user as a potential action event,
if the user selects the potential action event, saving it as an action event, the event processing server presenting the action event to a user by:
applying an action event rule to the action event,
presenting a draft message to the user.

20. The system of claim 19 wherein the event processing server presents a partner to the user after applying an action event rule to an action event, event processing server contacting the partner via API.

21. A method for identifying potential life events comprising:
receiving only selected social media posts based on filtering criteria including one or more of: key words and level of engagement from other users; and
using one or more computer implemented machine learning algorithm to prioritize a likelihood of a life event or status change event having occurred based on the received selected social media posts.

22. A computer implemented method for identifying a type of life event associated with a social media post comprising:
analyzing a text of the social media post and one or more of: associated comments, reactions, interactions, and emoji-style indicators for sentiment and key words; and
using a Machine Learning algorithm to classify said social media post as being associated with a type of life event.
